(19) United States
(12) Patent Application Publication
(10) Pub. No.: US 2012/0182000 A1
(43) Pub. Date: Jul. 19, 2012

(54) SOFT START CIRCUIT

(75) Inventors: Duk You KIM, Seoul (KR); Chong Eun Kim, Daejeon (KR); Gun Woo Moon, Daejeon (KR); Don Sik Kim, Gunpo (KR); In Ho Cho, Seoul (KR)

(73) Assignee: SAMSUNG ELECTRO-MECHANICS CO., LTD./ Korea Advanced Institute of Science and Technology

(21) Appl. No.: 13/341,623

(22) Filed: Dec. 30, 2011

(30) Foreign Application Priority Data
Jan. 19, 2011 (KR) 10-2011-0005577

(51) Int. Cl. G05F 1/46

(52) U.S. Cl. 323/282

(57) ABSTRACT

There is provided a soft start circuit including: a resonator generating a resonant voltage; a voltage detector detecting an output voltage of a power converter; a reference voltage selector selecting one of a voltage detected by the voltage detector and the resonant voltage as a reference voltage, based on a driving signal for turning the power converter on or off; and an error amplifier generating a control signal for controlling the output voltage of the power converter from the reference voltage selected by the reference voltage selector and the voltage detected by the voltage detector. The soft start circuit is capable of preventing semiconductor devices of the power converter from being burned out and preventing overshooting of the output voltage.

### CROSS-REFERENCE TO RELATED APPLICATIONS

This application claims the priority of Korean Patent Application No. 10-2011-0005577 filed on Jan. 19, 2011, in the Korean Intellectual Property Office, the disclosure of which is incorporated herein by reference.

### BACKGROUND OF THE INVENTION

1. Field of the Invention

The present invention relates to a soft start circuit, and more particularly, to a soft start circuit capable of preventing power converter semiconductor devices from being burned out and preventing overshooting of an output voltage.

2. Description of the Related Art

In general, a power converter is a device for raising or lowering the voltage level of input power to a predetermined level to output power having a predetermined voltage. A power converter is indispensable in various devices for SMPS (Switching Mode Power Supply), motor driving, or the like.

This power converter utilizes a voltage control method, by which an output voltage is compared with a reference voltage to control an on-off function of a switching element contained in the power converter, in order to control the output voltage. According to this voltage control method, since a reference voltage of an error amplifier may be high at the time of early driving of the power converter, the switching element of the power converter is operated at the maximum duty ratio, and thus, an output capacitor installed at an output terminal of the power converter is charged to a predetermined output voltage level. In this case, a section in which the current of an inductor or a transformer of the power converter is built up may be enlarged. This causes an initial inrush current to be generated.

In order to prevent this initial inrush current, a soft start method of gradually increasing the duty ratio is being studied. However, the soft start method has a defect in that overshooting may be generated in an output voltage while a transient state is changed to a normal state.

Further, the output voltage is gradually decreased at the time of the turning off of the power converter. Therefore, when the power converter is again turned on, while the output voltage remains high, a voltage difference between a reference voltage and the output voltage is large and thus, current flows inversely through an inductor of the power converter. This may cause semiconductor devices inside the power converter to be burned out.

### SUMMARY OF THE INVENTION

An aspect of the present invention provides a soft start circuit capable of preventing power converter semiconductor devices from being burned out and preventing the overshooting of an output voltage.

According to an aspect of the present invention, there is provided a soft start circuit, including: a resonator generating a resonant voltage; a voltage detector detecting an output voltage of a power converter; a reference voltage selector selecting one of a voltage detected by the voltage detector and the resonant voltage as a reference voltage, based on a driving signal for turning the power converter on or off; and an error amplifier generating a control signal for controlling the output voltage of the power converter from the reference voltage selected by the reference voltage selector and the voltage detected by the voltage detector.

The reference voltage selector may select the resonant voltage as the reference voltage when the driving signal is a first driving signal for turning the power converter on, and select the voltage detected by the voltage detector as the reference voltage when the driving signal is a second driving signal for turning the power converter off.

The reference voltage selector may include: a first switching element having a first terminal connected to an output terminal of the voltage detector and a second terminal connected to an output terminal of the resonator, the first switching element opening or closing the connection between the first terminal and the second terminal by a voltage difference between a first control terminal to which a switching signal is inputted and the second terminal; and a second switching element having a third terminal connected to the first control terminal of the first switching element and a fourth terminal connected to the ground, the second switching element opening or closing the connection between the third terminal and the fourth terminal by a voltage difference between a second control terminal to which a switching signal is inputted and the fourth terminal.

The reference voltage selector may further include a voltage follower between the first terminal of the first switching element and the output terminal of the voltage detector.

The resonator may include: a driving power; a resistor having one end connected to the driving power; and a resonant capacitor connected between the other terminal of the resistor and the ground. Herein, an output terminal which is a contact point of the other end of the resistor and the resonant capacitor may be connected to the second terminal of the first switching element.

The reference voltage selector may further include a resistor having one end connected to the fourth terminal of the second switching element and the other end connected to the ground.

The reference voltage selector may include: a comparator having a negative (−) terminal connected to the output terminal of the voltage detector and a positive (+) terminal connected to the output terminal of the resonator; a third switching element having a third control terminal connected to an output of the comparator, a fifth terminal connected to the output terminal of the resonator, a sixth terminal connected to the ground; and a diode having an anode connected to the third control terminal and a cathode to which a driving signal for turning the power converter on or off is applied.

The resonator may include: a driving power; a resistor having one end connected to the driving power; and a resonant capacitor connected between the other terminal of the resistor and the ground. Herein, an output terminal which is a contact point of the other end of the resistor and the resonant capacitor may be connected to the fifth terminal of the third switching element.

The reference voltage selector may further include a resistor having one end connected to the sixth terminal of the third switching element and the other end connected to the ground.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of an entire system, including a soft start circuit, according to an exemplary embodiment of the present invention;

FIG. 2 is a circuit diagram of a soft start circuit according to an exemplary embodiment of the present invention;

FIG. 3 is a waveform diagram showing a driving signal and a reference voltage of a soft start circuit according to an exemplary embodiment of the present invention; and

FIG. 4 is a circuit diagram of a soft start circuit according to another exemplary embodiment of the present invention.

### DETAILED DESCRIPTION OF THE PREFERRED EMBODIMENT

Hereinafter, exemplary embodiments will be described in detail with reference to the accompanying drawings so that they could be easily practiced by those skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

In addition, unless explicitly described to the contrary, the word “comprise” and variations such as “comprises” or “comprising,” will be understood to imply the inclusion of stated elements but not the exclusion of any other elements.

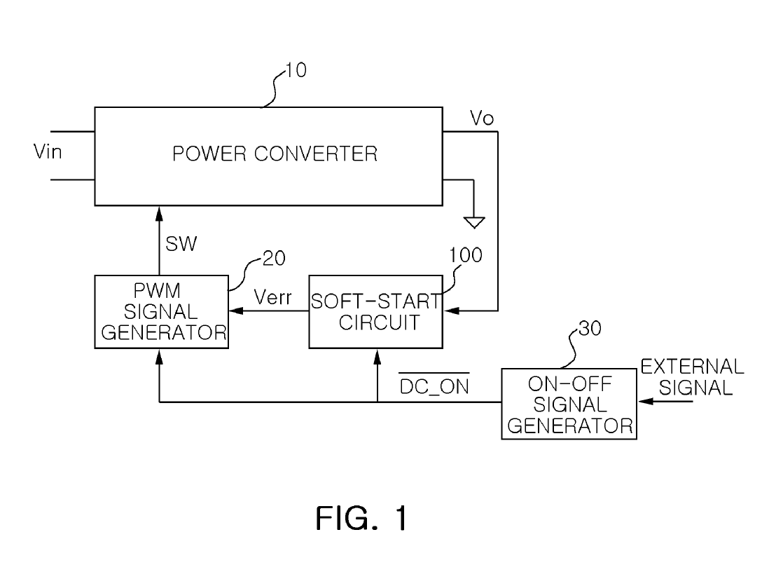

FIG. 1 is a block diagram of an entire system, including a soft start circuit, according to an exemplary embodiment of the present invention. The entire system may include a power converter 10, converting an input voltage Vin to a constant output voltage Vo to output the output voltage, a soft start circuit 100, receiving a feedback on the output voltage Vo of the power converter 10 to generate a control signal Verr, a PWM signal generator 20, generating a PWM: signal SW for controlling switching elements of the power converter 10 according to the control signal Verr generated by the soft start circuit 100, and an on-off signal generator 30, generating a driving signal DC_ON for turning the power converter 10 on or off according to an external signal inputted from the outside.

More specially, the power converter 10 may include a DC/DC converter, such as, a Buck converter, a boost converter, a Buck-boost converter, a flyback converter, a half bridge converter, or the like. The power converter 10 converts the input voltage Vin into a constant output voltage Vo to output the output voltage Vo.

The soft start circuit 100 receives the feedback on the output voltage Vo of the power converter 10 to generate the control signal Verr, and transmits the control signal Verr to the PWM signal generator 20. Constitutions and operations of this soft start circuit 100 will be described in detail later.

The PWM signal generator 20 controls a plurality of switching elements included in the power converter 10 according to the control signal Verr transmitted from the soft start circuit 100.

When the external signal for controlling the driving of the power converter 10 is inputted, the on-off signal generator 30 generates the driving signal D̅C̅_̅O̅N̅ for turning the power converter 10 on or off by the inputted external signal. More specially, the driving signal D̅C̅_̅O̅N̅ may be one of a first driving signal for turning the power converter 10 on and a second driving signal for turning the power converter 10 off. The generated driving signal D̅C̅_̅O̅N̅ may be applied to the soft start circuit 100 and simultaneously applied to the PWM signal generator 20 in order to generate an appropriate control signal Verr.

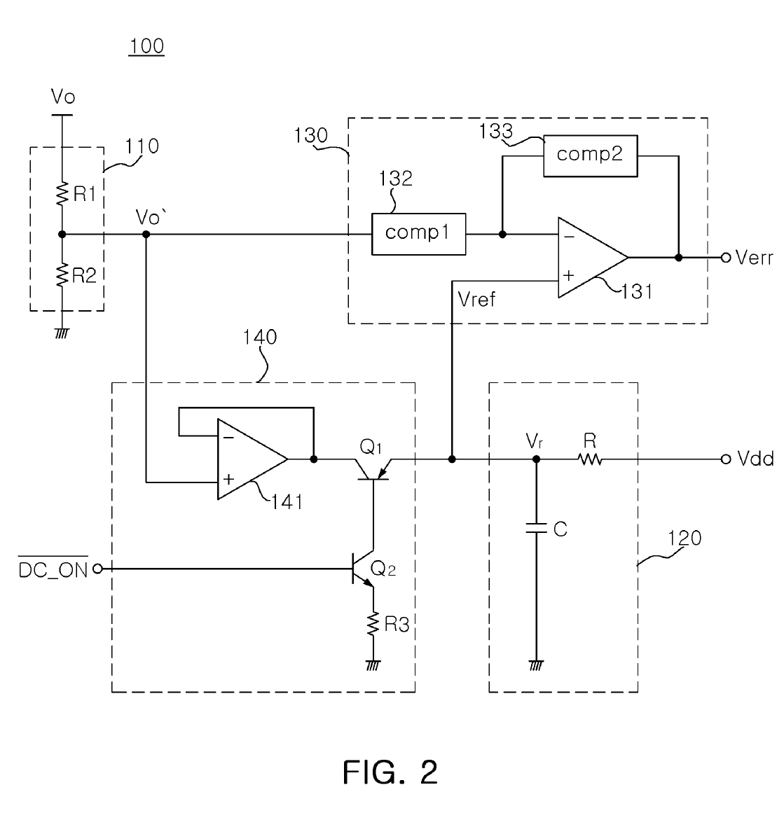

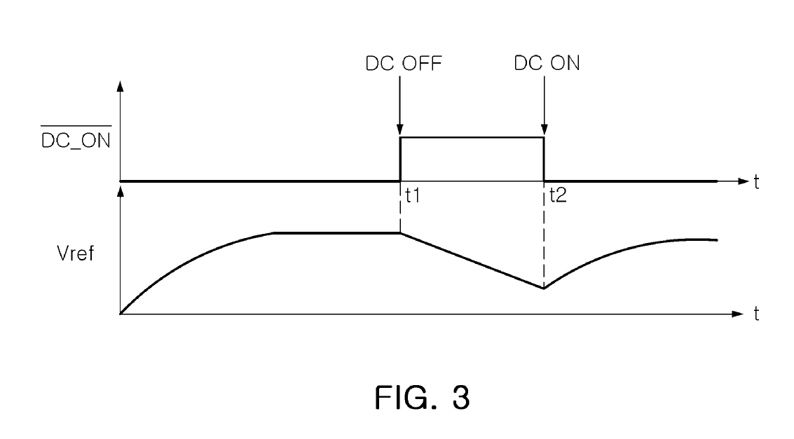

FIG. 2 is a circuit diagram of a soft start circuit 100 according to an exemplary embodiment of the present invention, and FIG. 3 is a waveform diagram showing a driving signal D̅C̅_̅O̅N̅ and a reference voltage Vref of a soft start circuit 100 according to an exemplary embodiment of the present invention.

Hereinafter, a circuit of a soft start circuit 100 according to an exemplary embodiment of the present invention will be described in detail with reference to FIG. 1 to FIG. 3.

In the exemplary embodiment of the present invention, a first switching element Q1 and a second switching element Q2 may include a BJT (Bipolar Junction Transistor) or an FET (Field Effect Transistor), and the BJT is figuratively shown in FIG. 2. In the BJT, a first terminal, a second terminal, and a first control terminal of the first switching element Q1 are a collector, an emitter, and a base respectively, and a third terminal, a fourth terminal, and a second control terminal of the second switching element Q2 are a collector, an emitter, and a base respectively. In the FET, a first terminal, a second terminal, and a first control terminal of the first switching element Q1 are a drain, a source, and a gate respectively, and a third terminal, a fourth terminal, and a second control terminal of the second switching element Q2 are a drain, a source, and a gate respectively.

The soft start circuit 100 according to the exemplary embodiment of the present invention may include an RC resonator 120 generating an RC resonant voltage, a voltage detector 110 detecting an output voltage Vo of a power converter 10, a reference voltage selector 140 selecting one of the voltage Vo′ detected by the voltage detector 110 and the RC resonant voltage Vr as a reference voltage Vref, based on the driving signal for turning the power converter 10 on or off, and an error amplifier 130 generating a control signal Verr for controlling the output voltage Vo of the power converter 10 from the reference voltage Vref selected by the reference voltage selector 140 and the voltage Vo′ detected by the voltage detector 110.

The voltage detector 110, which may include resistors R1 and R2 connected in series, detects the output voltage Vo of the power converter 10, and outputs the voltage Vo′ divided according to a law of resistance division.

The RC resonator 120 may include a resistor R having one end connected to a driving power Vdd and the other end connected to a resonant capacitor C, and the resonant capacitor C connected between the other end of the resistor R and the ground. An output terminal of the RC resonator which is a contact point of the other end of the resistor R and the resonant capacitor C may be connected to the second terminal of the first switching element Q1. This RC resonator 120 generates the RC resonant voltage Vr by charging the resonant capacitor C by the driving power Vdd.

In the error amplifier 130, the voltage Vo′ detected by the voltage detector 110 is applied to a negative (−) terminal of an OP amp 131 and the reference voltage Vref is applied to a positive (+) terminal of the OP amp 131. In addition, the error amplifier 130 may be constituted as a negative feedback circuit in which a first compensator 132 and a second compensator 133 for appropriate gain control are added. The first compensator 132 and the second compensator 133 may be constituted of elements such as resistors, capacitors, inductors, and the like. This error amplifier 130 receives the reference voltage Vref and the voltage Vo′ detected by the voltage detector 110, generates the control signal Verr based on a difference between both of the inputted voltages Vref and Vo′, and outputs the generated control signal Verr to the PWM signal generator 20. As such, the first compensator 132 and the second compensator 133 are constituted of the appropriate elements, and thus, the above-described control signal Verr can be generated to have various signal types, such as P (Proportional) control, PI (Proportional Integral) control, PID (Proportional Integral Differential) control, and the like. This matter is obvious to those skilled in the art, and thus a detailed description thereof will be omitted.

The reference voltage selector 140 selects the RC resonant voltage Vr as the reference voltage Vref when the driving signal D̅C̅_̅O̅N̅ is the first driving signal for turning the power converter 10 on, and selects the voltage Vo′ detected by the voltage detector 110 as the reference voltage Vref when the driving signal D̅C̅_̅O̅N̅ is the second driving signal for turning the power converter 10 off. In the exemplary embodiment of the present invention, the driving signal DC-ON is supposed to be the first driving signal for turning the power converter 10 on when the driving signal D̅C̅_̅O̅N̅ has a low (L) voltage level, and the second driving signal for turning the power converter 10 off when the driving signal D̅C̅_̅O̅N̅ has a high (H) voltage level.

More specially, the reference voltage selector 140 may include a first switching element Q1 and a second element Q2. The first switching element Q1 has a first terminal connected to an output terminal of the voltage detector 110 and a second terminal connected to an output terminal of the RC resonator 120. The first switching element Q1 opens or closes the connection between the first terminal and the second terminal by a voltage difference between a first control terminal to which a switching signal is inputted and the second terminal. The second switching element Q2 has a third terminal connected to the first control terminal of the first switching element Q1 and a fourth terminal connected to the ground. The second switching element Q2 opens or closes the connection between the third terminal and the fourth terminal by a voltage difference between a second control terminal to which a driving signal DC_ON inputted and the fourth terminal.

In addition, a voltage follower 141 may be disposed between the first terminal of the first switching element Q1 and the output terminal of the voltage detector 110.

Hereinafter, an operational principle of the soft start circuit 100 according to the exemplary embodiment of the present invention will be described in detail with reference to FIG. 1 to FIG. 3.

Referring to FIGS. 1 to 3, in the beginning, at t=0, when a first driving signal ( D̅C̅_̅O̅N̅ L) for turning the power converter 10 on is applied, a voltage difference between the base and the emitter of the second switching element Q2 is 0V. As a result, the second switching element Q2 is turned off, and thus the first switching element Q1 is turned off. As the first switching element Q1 is turned off, the resonant capacitor C is charged to the smoothly rising resonant voltage Vr by the driving power Vdd. The resonant voltage Vr may be transmitted as the reference voltage Vref to the error amplifier 130, and the error amplifier 130 may generate the control signal Verr from the resonant voltage Vr and the voltage Vo′ detected by the voltage detector 110.

Meanwhile, the PWM signal generator 20 receives the control signal Verr generated by the error amplifier 130 to generate a PWM signal SW for tracking the reference voltage Vref, and transmits the generated PWM signal SW to the power converter 10. The power converter 10 controls inside switching elements (not shown) based on the PWM signal SW transmitted from the PWM signal generator 20, thereby controlling the output voltage Vo to track the reference voltage Vref. Herein, the reference voltage Vref is a smoothly rising RC resonant voltage, and thus, this can prevent overshooting of the output voltage Vo in the power converter 10.

Then, in the case that at t1, a signal DC OFF for turning the power converter 10 off, a second driving signal ( D̅C̅_̅O̅N̅ H) is applied; that is, when the second driving signal ( D̅C̅_̅O̅N̅ H) is applied, the second switching element Q2 may be turned on by a voltage difference between the base and the emitter of the second switching element Q2. As the second switching element Q2 is turned on to generate a voltage difference between the base and the emitter of the first switching element Q1, the first switching element Q1 is also turned on. Herein, the voltage Vo′ detected by the voltage detector 110 may be transmitted to the error amplifier 130 as the reference voltage Vref.

More specially, as the power converter 10 is turned off, the voltage Vo′ detected by the voltage detector 110 is reduced to become smaller than the RC resonant voltage Vr. Herein, an amount of voltage corresponding to a voltage difference between the RC resonant voltage Vr and the voltage Vo′ detected by the voltage detector 110 is discharged to the output terminal of the voltage follower 141 as a current. In other words, the voltage follower 141 functions as a current sink. Therefore, as shown in FIG. 3, the reference voltage Vref is reduced according to the voltage Vo′ detected by the voltage detector 110. This reference voltage Vref is used in generating the control signal Verr, as described above.

Then, in the case that at t2, a signal DC ON for restarting the power converter 10, the first driving signal ( D̅C̅_̅O̅N̅ L), is applied; that is, as described above, when the first driving signal ( D̅C̅_̅O̅N̅ L) for turning the power converter 10 on is applied, a voltage difference between the base and the emitter of the second switching element Q2 is 0V. As a result, the second switching element Q2 is turned off, and thus the first switching element Q1 is also turned off. As the first switching element Q1 is turned off, the resonant capacitor C is charged to the smoothly rising resonant voltage Vr by the driving power Vdd. The resonant voltage Vr is transmitted to the error amplifier 130 as the reference voltage Vref, and the error amplifier 130 generates the control signal Verr from the resonant voltage Vr and the voltage Vo′ detected by the voltage detector 110. As such, according to the exemplary embodiment of the present invention, the reference voltage Vref and the voltage Vo′ detected by the voltage detector 110 may have the same voltage level even at the time of restarting of the power converter 10, thereby preventing current from flowing inversely through an inductor (not shown) at the output terminal of the power converter 10. Therefore, the exemplary embodiment of the present invention is capable of preventing semiconductor devices inside the power converter 10 such as switching elements from being burned out.

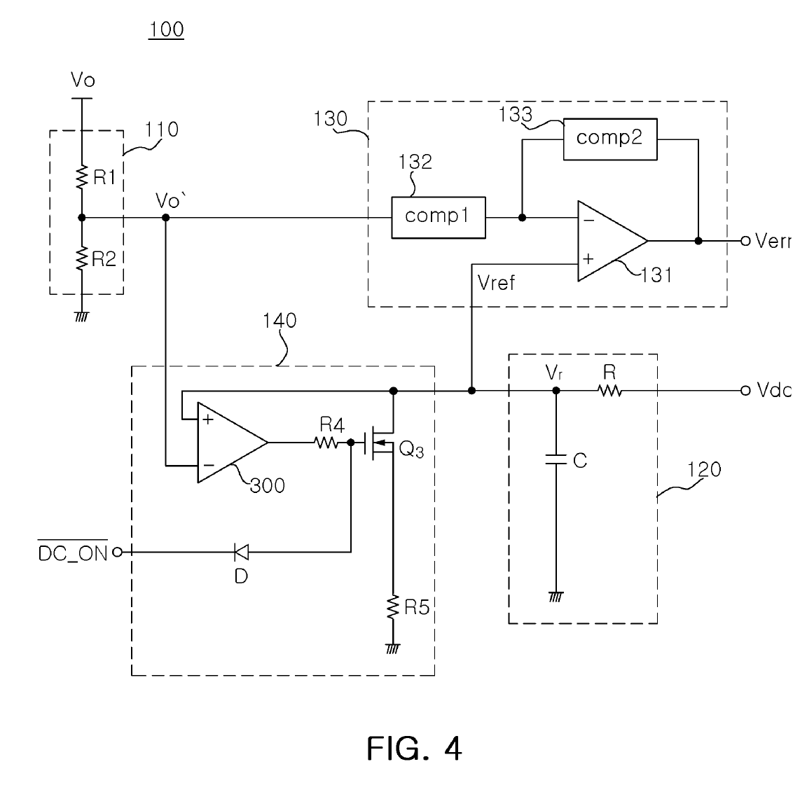

FIG. 4 is a circuit diagram of a soft start circuit according to another exemplary embodiment of the present invention. A reference voltage selector 140 shown in FIG. 4 is constituted differently as compared with the reference voltage selector shown in FIG. 2. Hereinafter, constitutions of the reference voltage selector 140 and an RC resonator 120 related to the reference voltage selector 140 will be described in detail.

As for an explanation of this exemplary embodiment of the present invention, a third switching element Q3 may include a BJT (Bipolar Junction Transistor) or an FET(Field Effect Transistor), and the FET(Field Effect Transistor) is figuratively shown in FIG. 3. In the FET, a fifth terminal, a sixth terminal, and a third control terminal of the third switching element Q3 are respectively a drain, a source, and a gate. In the BJT, a fifth terminal, a sixth terminal, and a third control terminal of the third switching element Q3 are respectively a collector, an emitter, and a base.

Referring to FIGS. 1 and 4, a reference voltage selector 140 may include a comparator 300, a third switching element Q3, and a diode D. The comparator 300 may have a negative (−) terminal connected to an output terminal of a voltage detector 110 and a positive (+) terminal connected to an output terminal of an RC resonator 120. The third switching element Q3 may have a third control terminal connected to an output terminal of the comparator 300, a fifth terminal connected to the output terminal of the RC resonator 120, and a sixth terminal connected to the ground. The diode D may have an anode connected to the third control terminal of the third switching element Q3 and a cathode to which a driving signal for turning the power converter 10 on or off is applied. A resistor R5 for current limits between the sixth terminal of the third switching element Q3 and the ground, and a resistor R4 for current limits between the comparator 300 and the third control terminal of the third switching element Q3 may be added.

In addition, the RC resonator 120 may include a resistor R having one end connected to a driving power Vdd, and a resonant capacitor C connected between the other end of the resistor R and the ground. An output terminal of the RC resonator which is a contact point of the other end of the resistor R and the resonant capacitor C may be connected to the fifth terminal of the third switching element Q3.

Hereinafter, an operational principle of the soft start circuit 100 according to the present exemplary embodiment of the present invention will be described in detail.

Referring to FIG. 1, FIG. 3, and FIG. 4, at t=0, when a signal DC ON for turning the power converter 10 on, that is, a first driving signal ( D̅C̅_̅O̅N̅ L) is applied, a gate-source voltage of the third switching element Q3 is almost 0V regardless of an output of the comparator 300. In other words, it is because the diode D is electrically conducted, and thus, the gate-source voltage of the third switching element Q3 is almost 0V when the output of the comparator 300 is high (H), and the gate-source voltage of the third switching element Q3 is almost 0V, while even when the output of the comparator 300 is low (L). Therefore, the third switching element Q3 remains to be turned off when the driving signal D̅C̅_̅O̅N̅ has a low (L) voltage level. As the third switching element Q3 is turned off, the resonant capacitor C is charged to the smoothly rising resonant voltage Vr by the driving power Vdd. The resonant voltage Vr may be transmitted to the error amplifier 130 as the reference voltage Vref, and the error amplifier 130 may generate the control signal Verr from the resonant voltage Vr and the voltage Vo′ detected by the voltage detector 110.

Meanwhile, the PWM signal generator 20 may receive the control signal Verr generated by the error amplifier 130 to generate a PWM signal SW for tracking the reference voltage Vref, and transmit the generated PWM signal SW to the power converter 10. The power converter 10 controls inside switching elements (not shown) based on the PWM signal SW transmitted from the PWM signal generator 20, thereby controlling the output voltage Vo to track the reference voltage Vref. Herein, the reference voltage Vref is a smoothly rising RC resonant voltage, and thus, this can prevent overshooting of the output voltage Vo in the power converter 10.

Then, at t1, in the case that a signal DC OFF for turning the power converter 10 off, the second driving signal ( D̅C̅_̅O̅N̅ H) is applied; the voltage of the driving signal DC ON is changed from low (L) to high (H). Therefore, the high (H) level voltage is applied to the cathode of the diode D, and thus, the third switching element Q3 is turned off according to the signal outputted from the comparator 300. In other words, the third switching element Q3 may be turned on when the output signal of the comparator 300 has a high (H) voltage level, and the third switching element Q3 may be turned off when the output signal of the comparator 300 has a low (L) voltage level. Herein, the voltage Vo′ detected by the voltage detector 110 is transmitted to the error amplifier 130 as the reference voltage Vref, while the driving signal D̅C̅_̅O̅N̅ has a high (H) voltage level.

More specially, at t1, the RC resonant voltage Vr is greater than the voltage Vo′ detected by the voltage detector 110. In other words, it is because the voltage Vo′ detected by the voltage detector 110 is not greater than the reference voltage Vref by tracking the RC resonant voltage Vr which is the reference voltage at t1. Therefore, a high (H)-level voltage signal is outputted from the comparator 300, and thus the third switching element Q3 is turned on. As the third switching element Q3 is turned on, the RC resonant voltage Vr charged in the resonant capacitor C is discharged through the third switching element Q3. However, when the voltage Vr charged in the resonant capacitor C is discharged such that the voltage Vr is smaller than the voltage Vo′ detected by the voltage detector 110, a low (L)-level voltage signal is outputted from the comparator 300 and the third switching element Q3 is turned off. As the third switching element Q3 is turned off, the resonant capacitor C starts to be recharged. When the voltage charged in the resonant capacitor C is equal to or greater than the voltage Vo′ detected by the voltage detector 110, the third switching element Q3 is again turned on. Therefore, the voltage charged in the resonant capacitor C starts to be discharged through the third switching element Q3. Through repetitive performance of the above-described procedure, the voltage Vo′ detected by the voltage detector 110 is transmitted to the error amplifier 130 as the reference voltage Vref, while the driving signal D̅C̅_̅O̅N̅ has a high (H) voltage level.

Then, at t2, when a signal DC ON for turning the power converter 10 on, a first driving signal ( D̅C̅_̅O̅N̅ L) is applied; a gate-source voltage of the third switching element Q3 is almost 0V regardless of an output of the comparator 300. In other words, it is because the diode D is electrically conducted when the output of the comparator 300 is high (H) and thus, the gate-source voltage of the third switching element Q3 is almost 0V, and the gate-source voltage of the third switching element Q3 is almost 0V even when the output of the comparator 300 is low (L). Therefore, the third switching element Q3 remains to be turned off when the driving signal D̅G̅_̅O̅N̅ has a low (L) voltage level. As the third switching element Q3 is turned off, the resonant capacitor C is again charged to the smoothly rising resonant voltage Vr by the driving power Vdd. The resonant voltage Vr may be transmitted to the error amplifier 130 as the reference voltage Vref, and the error amplifier 130 may generate the control signal Verr from the resonant voltage Vr and the voltage Vo′ detected by the voltage detector 110.

As such, according to the exemplary embodiment of the present invention, since the reference voltage Vref and the voltage Vo′ detected by the voltage detector 110 have the same voltage level, even at the time of restarting of the power converter 10, current may be prevented from flowing inversely through the inductor (not shown) at the output terminal of the power converter 10. Therefore, the exemplary embodiment of the present invention is capable of preventing semiconductor devices inside the power converter 10 such as switching elements from being burned out.

As set forth above, according to an embodiment of the present invention, semiconductor devices of the power converter may be prevented from being burned out and may prevent overshooting of an output voltage by selecting one of the resonant voltage and the output voltage of the power converter as the reference voltage inputted to the error amplifier according to the driving signal for turning the power converter on or off.

While the present invention has been shown and described in connection with the exemplary embodiements, it will be apparent to those skilled in the art that modification and variation can be made withough departing from the spirit and scope of the invention as defined by the appended claims.

What is claimed is:

1. A soft start circuit, comprising:
a resonator generating a resonant voltage;
a voltage detector detecting an output voltage of a power converter;
a reference voltage selector selecting one of a voltage detected by the voltage detector and the resonant voltage as a reference voltage, based on a driving signal for turning the power converter on or off; and
an error amplifier generating a control signal for controlling the output voltage of the power converter from the reference voltage selected by the reference voltage selector and the voltage detected by the voltage detector.

2. The soft start circuit of claim 1, wherein the reference voltage selector selects the resonant voltage as the reference voltage when the driving signal is a first driving signal for turning the power converter on, and selects the voltage detected by the voltage detector as the reference voltage when the driving signal is a second driving signal for turning the power converter off.

3. The soft start circuit of claim 1, wherein the reference voltage selector includes:
a first switching element having a first terminal connected to an output terminal of the voltage detector and a second terminal connected to an output terminal of the resonator, the first switching element opening or closing the connection between the first terminal and the second terminal by a voltage difference between a first control terminal to which a switching signal is inputted and the second terminal; and
a second switching element having a third terminal connected to the first control terminal of the first switching element and a fourth terminal connected to the ground, the second switching element opening or closing the connection between the third terminal and the fourth terminal by a voltage difference between a second control terminal to which a switching signal is inputted and the fourth terminal.

4. The soft start circuit of claim 3, wherein the reference voltage selector further includes a voltage follower between the first terminal of the first switching element and the output terminal of the voltage detector.

5. The soft start circuit of claim 3, wherein the resonator includes:
a driving power;
a resistor having one end connected to the driving power; and
a resonant capacitor connected between the other terminal of the resistor and the ground,
an output terminal which is a contact point of the other end of the resistor and the resonant capacitor being connected to the second terminal of the first switching element.

6. The soft start circuit of claim 3, wherein the reference voltage selector further includes a resistor having one end connected to the fourth terminal of the second switching element and the other end connected to the ground.

7. The soft start circuit of claim 1, wherein the reference voltage selector includes:
a comparator having a negative (−) terminal connected to the output terminal of the voltage detector and a positive (+) terminal connected to the output terminal of the resonator;
a third switching element having a third control terminal connected to an output of the comparator, a fifth terminal connected to the output terminal of the resonator, a sixth terminal connected to the ground; and
a diode having an anode connected to the third control terminal and a cathode to which a driving signal for turning the power converter on or off is applied.

8. The soft start circuit of claim 7, wherein the resonator includes:
a driving power;
a resistor having one end connected to the driving power; and
a resonant capacitor connected between the other terminal of the resistor and the ground,
an output terminal which is a contact point of the other end of the resistor and the resonant capacitor being connected to the fifth terminal of the third switching element.

9. The soft start circuit of claim 7, wherein the reference voltage selector further includes a resistor having one end connected to the sixth terminal of the third switching element and the other end connected to the ground.
